(19) United States
(12) Patent Application Publication
(10) Pub. No.: US 2014/0195662 A1
(43) Pub. Date: Jul. 10, 2014

(54) MANAGEMENT OF MOBILE APPLICATIONS IN COMMUNICATION NETWORKS

(71) Applicants: Srinivasan PULIPAKKAM, Sunnyvale, CA (US); Andrew Hansen, Portland, OR (US)

(72) Inventors: Srinivasan PULIPAKKAM, Sunnyvale, CA (US); Andrew Hansen, Portland, OR (US)

(21) Appl. No.: 13/851,912

(22) Filed: Mar. 27, 2013

(30) Foreign Application Priority Data
Jan. 10, 2013 (IN) 93/MUM/2013

(51) Int. Cl. H04L 29/08

(52) U.S. Cl. CPC H04L 67/10
USPC 709/223

(57) ABSTRACT

Method and system for management of applications in communication networks are described. The method comprises classifying a plurality of users into one or more user groups based on a user assignment information, where the user assignment information includes at least one of a field of work, a designation, an operating system of a user device of a user, and an access level of the user. The method further comprises assigning a version of a mobile application to each of the user groups based on the one or more user groups. Further, the method comprises providing the version of the mobile application to each of the plurality of the users of the one or more user groups.

### TECHNICAL FIELD

The present subject matter relates, in general, to mobile applications and, in particular, to a system and a method for management of mobile applications in communication networks.

### BACKGROUND

With advancement in technology, mobile applications have become an integral part of day to day lives for majority of users across the globe. These applications provide a convenient platform to the users for accessing several services such as Mobile TV, weather information, stock updates, live scores, multimedia messaging, and the like. Use of mobile applications can also be found in enterprises and organizations, where mobile applications offering utility tools are extensively used in day to day work.

Typically, mobile applications can be found available in several application stores. The mobile application stores offer a convenient platform to users to search and install applications of their choice and according to their utility. Further, these mobile application stores offer time to time upgrades available for these applications. The upgrades are often directed towards improving and adding new features in the mobile application in order to provide better utility to the users. However, in some cases, the upgrade might lead to malfunctioning of the mobile application due to, for example, a bug in the upgraded version of the mobile application or non-compatibility of the mobile application with the user's mobile device, thereby leading to a dissatisfactory experience for the users.

### SUMMARY

This summary is provided to introduce concepts related to management of mobile applications in communication networks. These concepts are farther described below in the detailed description. This summary is not intended to identify essential features of the claimed subject matter nor is it intended for use in determining or limiting the scope of the claimed subject matter.

In one embodiment, method and system for management of applications in communication networks are described. The method comprises classifying a plurality of users into one or more user groups based on user assignment information, wherein the user assignment information includes at least one of a field of work, a designation, an operating system of a user device of a user, and an access level of the user. The method further comprises assigning a version of a mobile application to each of the user groups based on the classification. Further, the method comprises providing the version of the mobile application to each of the plurality of the users of the one or more user groups.

### BRIEF DESCRIPTION OF THE DRAWINGS

The detailed description is described with reference to the accompanying figure(s). In the figure(s), the left-most digit(s) of a reference number identifies the figure in which the reference number first appears. The same numbers are used throughout the figure(s) to reference like features and components. Some embodiments of systems and/or methods in accordance with embodiments of the present subject matter are now described, by way of example only, and with reference to the accompanying figure(s), in which:

FIG. 1 illustrates a network environment implementing application distribution system, according to an embodiment of the present subject matter.

FIG. 2 illustrates a method for managing mobile applications, according to an embodiment of the present subject matter.

### DETAILED DESCRIPTION

Conventionally, enterprises and organizations provide mobile applications to users for providing support by offering several utility tools. The mobile applications typically provide several utility tools to the users, helping the users to perform various work related tasks. Additionally, the mobile applications also help in better management of documents and for monitoring resources of the enterprises.

Further, the mobile applications are usually updated from time to time and new features are added by the enterprises and organizations to enhance the utility of these mobile applications. Subsequently, a new version of the mobile application including the updates is distributed to all the users of the enterprise. Generally, an administrator distributes the mobile application to the users through a central server. The central server includes a latest version of the mobile application at all times. Often, the mobile applications encounter problems when upgraded due to several reasons, such as a software bug, an application coding error, and the like. In such a scenario the administrator need to roll back to a previous version of the mobile application by installing the previous version of the mobile application in the central server. The previous version is subsequently distributed as the new version to the users. The whole procedure of loading and unloading of mobile applications is a tedious procedure and consumes a lot of time and resources, thereby often leading to delay, thus affecting work environment.

In another conventional approach, each user is associated with a user device and user device groups are formed by the administrator. Further, each of the user device group is associated with a different version of the mobile application based on several parameters, such as a department to which the user belongs. For example, a finance department of an organization may have a different version of the application as compared to a version assigned to a customer support group. However, assigning multiple versions of the mobile application might not be feasible in a situation where a user from a different department needs to access some service using a user device belonging to a different department.

In accordance with the present subject matter, a method and a system for managing mobile applications is described. In one implementation, an application distribution system is configured to manage and distribute mobile applications to the users based on user groups. For the purpose, the application distribution system is configured to categorize users into user groups based on a user assignment information. In one implementation, the user assignment information may include information, such as a field of work, a designation, an operating system of a user device of the user, an access level of the user, and the like. In one implementation, the administrator is responsible for categorizing the users into the user groups. For example, all the users working in the finance department are classified into a finance user group. In another implementation, the users may be classified based on the designation of the user. For example, vice presidents of different departments may be classified into one group.

In one implementation, the application distribution system is configured to assign a version of the mobile application to each of the user group. The assigning of the version for each of the user group may be determined by the administrator based on the user assignment information. In another implementation, a latest version of the mobile application may be assigned to a group of test users for testing and reviewing the latest version. In the said implementation, the application distribution system may request the test user group to provide a performance feedback of the latest version of the mobile application. In a scenario where the present version of the mobile application has developed some software bug, the application distribution system is configured to roll back the user groups to a previous version of the mobile application as determined by the administrator. In the said scenario, the application distribution system forwards the present version of the mobile application with software bug to a group of beta testers for identifying and fixing the software bug. In order to facilitate the user groups to switch to a latest or a previous version of the mobile application in case of a rollback, the application distribution system may send a push notification to the users, in one implementation.

In one embodiment, the application distribution system is configured to assign two different versions of the mobile application having different features, to two different user groups. Further, the application distribution system may request the two different user groups to provide a performance feedback of the version of the mobile application assigned to them. In one scenario, the application distribution system may exchange the version of the mobile application between the two different user groups and again receive the performance feedback for the same.

In one implementation, the application distribution system is configured to maintain an internal database for storing application packages corresponding to all previous versions of the mobile application. The application package may be understood as a package including all software and binary executable files. Storing of all the previous versions of the mobile application helps in a quick rollback to a previous version in a scenario where the version of the mobile application develops some critical bug or the performance feedback of the version of the mobile application is not optimum.

The system and the method in accordance with the present subject matter provide an efficient application distribution system for dynamically managing and assigning, multiple versions of a mobile application in an enterprise. Moreover, the application distribution allows sharing of user device amongst different users belonging to different groups.

These and other advantages of the present subject matter would be described in greater detail in conjunction with the following figures. While aspects of described systems and methods for management of mobile applications in communication networks can be implemented in any number of different computing systems, environments, and/or configurations, the embodiments are described in the context of the following exemplary system(s).

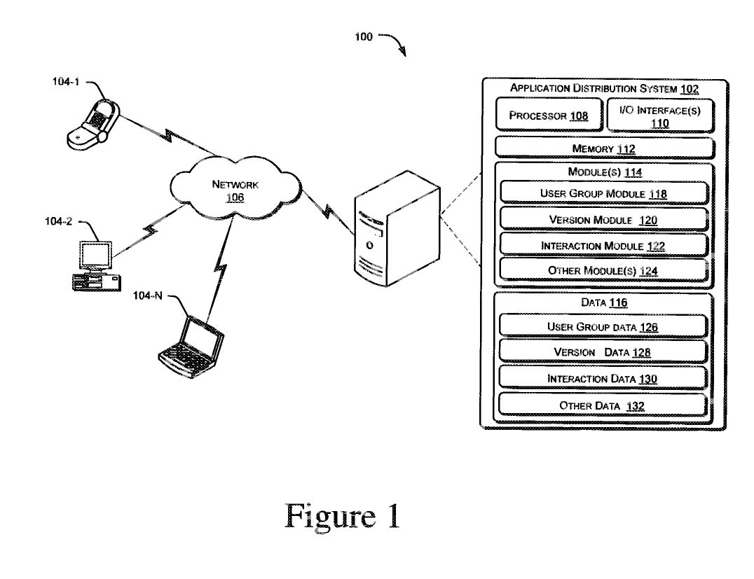

FIG. 1 illustrates a network environment 100 implementing an application distribution system 102, in accordance with an embodiment of the present subject matter. In one implementation, the network environment 100 can be a public network environment, including thousands of personal computers laptops, various servers, such as blade servers, and other computing devices. In another implementation, the network environment 100 can be a private network environment with a limited number of computing devices, such as personal computers, servers, laptops, and/or communication devices, such as mobile phones and smart phones.

The application distribution system 102 is communicatively connected to a plurality of user devices 104-1, 104-2, . . . , and 104-N, collectively referred to as user devices 104 and individually referred to as a user device 104, through a network 106.

The application distribution system 102 and the user devices 104 may be implemented in a variety of computing devices, including, servers, a desktop personal computer, a notebook or portable computer, a workstation, a mainframe computer, a laptop and/or communication device, such as mobile phones and smart phones. Further, in one implementation, the application distribution system 102 may be a distributed or a centralized network system in which different computing devices may host one or more of the hardware or software components of the application distribution system 102.

The application distribution system 102 may be connected to the user devices 104 over the network 106 through one or more communication links. The communication links may be enabled through a desired form of communication, for example, via dial-up modem connections, cable links, digital subscriber lines (DSL), wireless, or satellite links, or any other suitable form of communication.

The network 106 may be a wireless network, a wired network, or a combination thereof. The network 106 can also be an individual network or a collection of many such individual networks, interconnected with each other and functioning as a single large network, e.g., the Internet or an intranet. The network 106 can be in as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 106 may include network devices, such as network switches, hubs, routers, for providing the one or more communication links. The network devices within the network 106 may interact with the application distribution system 102, the user devices 104, through the communication links.

According to an embodiment of the present subject matter, the application distribution system 102 is configured to manage and assign multiple versions of a mobile application to different user groups based on a user assignment information determined by an administrator.

For the purpose, the application distribution system 102 may include one or more processor(s) 108, I/O interface(s) 110, and a memory 112 coupled to the processor 108. The processor(s) 108 can be a single processing unit or a number of units, all of which could include multiple computing units. The processor 108 may be implemented as one or more microprocessors, microcomputers, microcontrollers, digital signal processors, central processing units, state machines, logic circuitries, and/or any devices that manipulate signals based on operational instructions. Among other capabilities, the processor 108 is configured to fetch and execute computer-readable instructions and data stored in the memory 112.

The I/O interface(s) 110 may include a variety of software and hardware interfaces, for example, interfaces for peripheral device(s), such as a keyboard, a mouse, a display unit, an external memory, and a printer. Further, the interface(s) 110 may enable the application distribution system 102 to communicate with other devices, such as, the user device 104, web servers and external databases. The I/O interface(s) 110 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface(s) 110 include one or more ports for connecting a number of computing systems with one another or to a network.

The memory 112 may include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In one implementation, the application distribution system 102 also includes module(s) 114 and data 116.

The module(s) 114, amongst other things, include routines, programs, objects, components, data structures, etc., which perform particular tasks or implement data types. The module(s) 114 may also be implemented as, signal processor(s), state machine(s), logic circuitries, and/or any other device or component that manipulate signals based on operational instructions.

Further, the module(s) 114 can be implemented in hardware, instructions executed by a processing unit, or by a combination thereof. The processing unit can comprise a computer, a processor, such as the processor 108, a state machine, a logic array or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the module(s) 114 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

In one implementation, the module(s) 114 further include a user group module 118, a version module 120, an interaction module 122, and other module(s) 124. The other modules 124 may include programs or coded instructions that supplement applications and functions of the application distribution system 102.

The data 116 serves, amongst other things, as a repository for storing data processed, received, and generated by one or more of the module(s) 114. The data 116 includes user group data 126, version data 128, interaction data 130, and other data 132. The other data 132 includes data generated as a result of the execution of one or more modules in the module(s) 114.

As described previously, the application distribution system 102 is configured to manage and distribute multiple versions of a mobile application to different users in an enterprise environment. For the purpose, the user group module 118 is configured to classify users into different user groups based on one or more predetermined rules. In one implementation, the predetermined rules may include a user assignment information, where the user assignment information comprise a field of work, a designation level, an access level, and the like, pertaining to each of the users as determined by an administrator. Further, the user assignment information may be updated from time to time by the administrator. In one implementation, the user group module 118 classifies the users based on a field of work to which the user belongs. For example, the user group module 118 may classify a set of users working in financial sector into a finance user group, another set of users working in customer services into a customer support group, and the like. In another implementation, the user group module 118 is configured to classify the users based on a designation of the user in the enterprise. The user group module 118 obtains the user assignment information stored in the user group data 126. In one embodiment, the user group module 118 is configured to classify the users into a user group based on an operating system of the user device 104 corresponding to each of the user in the user group.

In another embodiment, the administrator may ascertain a test user group for testing a new version of the mobile application. For the purpose, the administrator may randomly pick the users from different groups and allocate them in the test user group. Subsequently, the administrator may update the user assignment information pertaining to the users of the test user group.

Further, the version module 120 is configured to assign a version of the mobile application to the user groups based on the user assignment information determined by the administrator. For example, the financial user group may be assigned a version 1.0 of the mobile application as compared to a version 2.0 assigned to the customer support group.

In one implementation, the version module 120 may assign the version of the mobile application to individual users based on the user assignment information, such as an access level of the user. For instance, the version module 120 may assign different versions to different users based on their designation. For example, the version module 120 may assign a version 1.1 of a mobile application to an accountant, whereas the version module may assign a version 1.2 of the mobile application to a department head of the group.

Further, the version module 120 may be configured to maintain an internal database for storing an application package corresponding to each version of the mobile application. As will be understood, the application package includes all software and binary executable files related to the mobile application, in one implementation, the version module 120 is configured to store the application packages of all previous versions of the mobile application as version information in the version data 128. Further, the version data 128 may also include assets related to the mobile application such as images, binaries, and the like, as would be understood by a person skilled in the art.

In one embodiment, the version module 120 is configured to obtain a previous version of the mobile application and provide it to the user groups if a new version of the mobile application has critical bugs. The version module 120, in one implementation, may be configured to provide the new version of the mobile application to a beta tester group for identifying and fixing the critical bug.

In another implementation, the version module 120 is configured to selectively distribute a latest version of the mobile application to a limited number of users as a trial version for obtaining feedback from the limited number of users. Further, the version module 120 may assign different version of the mobile application to two user groups for NB testing as would be understood by a person skilled in the art. In one embodiment, the version module 120 is configured to assign the mobile application to the user groups based on an operating system used by the users of the user groups.

In one implementation, the version module 120 is configured to generate a notification for a new version of an application being loaded in the application distribution system 102. For example, a notification is generated when a new version, say version 3.0 of the mobile application is available. Subsequently, the notification is saved in the version data 128.

Subsequently, the interaction module 122 is configured to send the notification to the user groups for updating to the new version of the mobile application. For the purpose, the interaction module 122 obtains the notification stored in the version data 128. In one embodiment, the interaction module 122 is configured to provide a platform, such as an enterprise application catalog, to a user for accessing and browsing the mobile applications enlisted in the enterprise application catalog. Based on the user assignment information, the version assigned to the user is displayed in the enterprise application catalog. The user may surf and install the mobile application through the user device 104. In one implementation, the interaction module 122 is configured to obtain and store a feedback from the users in interaction data 130.

Management and distribution of applications based on user groups helps in implementing the enterprise application catalog in a dynamic environment where multiple users might share the same user device. Moreover, maintaining a history of multiple versions of the mobile application helps in a quick rollback to a previous version in case a critical bug is detected in a latest version of the mobile application.

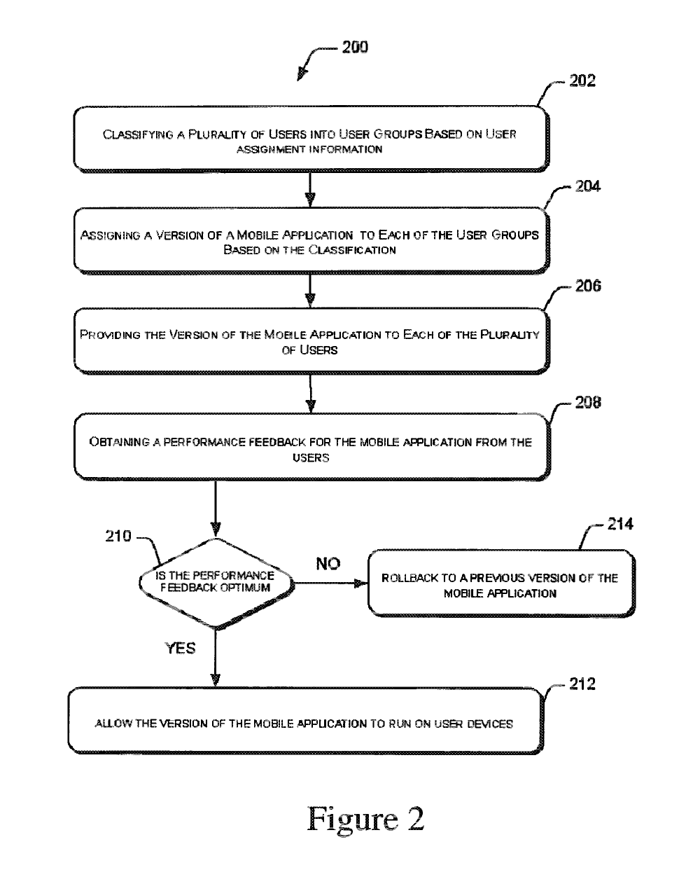

FIG. 2 illustrates a method 200 for management of applications in communication networks, in accordance with an embodiment of the present subject matter. The order in which the method is described is not intended to be construed as a limitation, and any number of the described method blocks can be combined in any order to implement the method 200 or any alternative methods. Additionally, individual blocks may be deleted from the methods without departing from the spirit and scope of the subject matter described herein. Furthermore, the method(s) can be implemented in any suitable hardware, software, firmware, or combination thereof.

The method(s) may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the method(s) can be performed by programmed computers. Herein, some embodiments are also intended to cover program storage devices, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and communication devices configured to perform said steps of the exemplary method(s).

At block 202, users are classified into user groups based on user assignment information. In one example, a user group module, such as the user group module 118 is configured to classify the users into the user groups based on the user assignment information. The user assignment information may include information like a field of work, a designation level, details about the operating system of a user device pertaining to each of the users, an access level information, and the like. In one implementation, an administrator determines the user assignment information and updates it in an application distribution system comprising the user group module. Subsequently, the user group module classifies the users into the user groups.

At block 204, a version of a mobile application is assigned to each of the user groups based on the classification. In one example, the version module 120 is configured to assign different versions of the mobile application to each of the user groups based on one or more predetermined rules. In one implementation, the version module 120 assigns the version based on a field of work to which the user group pertains. For example, a version 1.0 of the mobile application may be assigned to a finance group and a version 2.0 of the mobile application may be assigned to a customer support group. Consequently, the users pertaining to each of these groups will get the version of the mobile application assigned to its user group. In another implementation, the version module 120 maintains a history of all versions of the mobile application. In one embodiment, a latest version of the mobile application may be assigned to a test user group for testing purposes. If a critical bug is spotted in the latest version of the mobile application, a previous version of the mobile application may be assigned to the user groups by the version module 120.

At block 206, the version of the mobile application is provided to each of the plurality of users. In one implementation, the interaction module 122 provides the assigned version of the mobile application to each of the user groups. In another implementation, the interaction module 122 provides a platform, such as an enterprise application catalog, to the users for selecting the mobile applications.

At block 208, a performance feedback for the mobile application is obtained from the user. In one example, the interaction module 122 receives the performance feedback of the version of the mobile application from the user groups.

At block 210, it is determined if the performance feedback is optimum or not. If it is determined that the performance feedback of the version of the mobile application is optimum and the version assigned to each of the user groups is running smoothly, which is the ‘YES’ path, the method proceeds to block 212 and the assigned version continues to be current version of the user groups. If determined otherwise, the method proceeds to ‘NO’ path, which is block 214.

At block 214, a rollback to a previous version of the mobile application is performed. In one example, the version module 120 assigns the previous version for the user groups in case of a rollback. The previous version may be determined by the administrator. Subsequently, the version module 120 may assign the current version of the mobile application to a beta tester group for identifying and fixing performance issues, such as a software bug in the current version.

I/We claim:

1. A method for management of mobile application in communication networks, the method comprising:
classifying a plurality of users into one or more user groups based on a user assignment information, wherein the user assignment information includes at least one of a field of work, a designation, an operating system of a user device of a user, and an access level of the user;
assigning a version of a mobile application to each of the user groups based on the one or more user groups; and
providing the version of the mobile application to each of the plurality of users based on the assigning of the version to the one or more user groups.

2. The method as claimed in claim 1, wherein the method further comprises:
receiving a performance feedback of the version of the mobile application from the plurality of users, wherein the performance feedback includes indication of presence of at least one of an error, a bug, and an internal error in the version of the mobile application; and
assigning a previous version of the mobile application from amongst a plurality of previous versions of the mobile application to the plurality of user groups.

3. The method as claimed in claim 1, wherein the method further comprises:
exchanging the version of the mobile application amongst the one or more user groups; and
receiving a performance feedback of the version of the mobile application from the one or more user groups.

4. The method as claimed in claim 1, wherein the version of the mobile application is at least one of an updated version and a previous version.

5. The method as claimed in claim 1, wherein the providing further comprises sending a push notification for indicating availability of the version of the mobile application for updation.

6. The method as claimed in claim 1, wherein the method further comprises storing the version of the mobile application and a plurality of previous versions of the mobile application in an internal database.

7. The method as claimed in claim 1, wherein the user assignment information includes at least one of a field of work, a designation, an access level, and an operating system of a user device corresponding to a user.

8. A application distribution system for managing mobile application in communication network, the application distribution system comprising:
a processor;
a user group module coupled to the processor, the user group module configured to classify a plurality of users into one or more user groups based on a user assignment information, wherein the user assignment information includes at least one of a field of work, a designation, an operating system of a user device of a user, and an access level of the user;
a version module coupled to the processor, the version module configured to assign a version of a mobile application to each of the user groups based on the one or more user groups; and
an interaction module coupled to the processor, the interaction module configured to provide the version of the mobile application to each of the plurality of the users of the one or more user groups.

9. The application distribution system as claimed in 8, wherein the version module is further configured to assign a previous version of the mobile application from amongst a plurality of previous version of the mobile application based on a performance feedback of the version of the mobile application, wherein the performance feedback includes indication of presence of at least one of an error, a bug, and an internal error in the version of the mobile application.

10. The application distribution system as claimed in 8, wherein the version module is further configured to exchange the version of the mobile application amongst the one or more user groups.

11. The application distribution system as claimed in claim 8, wherein the version module is further configured to store the plurality of the previous version of the mobile application.

12. The application distribution system as claimed in 8, wherein the interaction module is further configured to receive a performance feedback of the version of the mobile application from the plurality of users, wherein the performance feedback includes indication of presence of at least one of an error, a bug, and an internal error in the version of the mobile application.

13. The application distribution system as claimed in 8, wherein the interaction module is further configured to send a push notification for updation to at least one of the updated version of the mobile application and the previous version of the mobile application.

14. A non-transitory computer-readable medium having embodied thereon a computer program for executing a method comprising:
classifying a plurality of users into one or more user groups based on a user assignment information, wherein the user assignment information includes at least one of a field of work, a designation, an operating system of a user device of a user, and an access level of the user;
assigning a version of a mobile application to each of the user groups based on the one or more user groups; and
providing the version of the mobile application to each of the plurality of the users of the one or more user groups.

15. The non-transitory computer-readable medium as claimed in claim 14, wherein the method further comprises:
receiving a performance feedback of the version of the mobile application from the plurality of users, wherein the performance feedback includes indication of presence of at least one of an error, a bug, and an internal error in the version of the mobile application; and
assigning a previous version of the mobile application from amongst a plurality of previous versions of the mobile application to the plurality of user groups.

16. The non-transitory computer-readable medium as claimed in claim 14, wherein the method further comprises
exchanging the version of the mobile application amongst the one or more user groups; and
receiving a performance feedback of the version of the mobile application from the one or more user groups

17. The non-transitory computer-readable medium as claimed in claim 14, wherein the method further comprises storing the version of the mobile application and a plurality of previous versions of the mobile application in an internal database.

18. The non-transitory computer-readable medium as claimed in claim 14, wherein the providing further comprises sending a push notification for indicating availability of the version of the mobile application for updation.
